(19) United States
(12) Patent Application Publication
(10) Pub. No.: US 2019/0178173 A1
(43) Pub. Date: Jun. 13, 2019

(54) DEVICE AND METHOD FOR CONTROLLING THE COMBINED INJECTION OF AIR AND EXHAUST GASSES AT THE INTAKE OF A SUPERCHARGED INTERNAL-COMBUSTION ENGINE

(71) Applicant: IFP Energies nouvelles, Rueil-Malmaison (FR)

(72) Inventors: Thierry COLLIOU, Les Côtes d'Arey (FR); Bruno WALTER, Chagnon (FR); Stephane VENTURI, Roiffieux (FR)

(21) Appl. No.: 16/321,175

(22) PCT Filed: Jul. 10, 2017
(86) PCT No.: PCT/EP2017/067302

§ 371 Date: Jan. 28, 2019

(30) Foreign Application Priority Data
Jul. 29, 2016 (FR) 1657402

(51) Int. Cl. F02D 41/00; F02D 9/08; F01D 17/10; F02B 37/04; F02B 37/16; F02M 26/05

(52) U.S. Cl. CPC F02D 41/0007; F02D 9/08; F01D 17/105; F02D 2041/0017; F02B 37/164; F02M 26/05; F02B 37/04

(57) ABSTRACT

The present invention relates to a device and to a method for controlling the amount of air fed to the intake of a turbocharged internal-combustion engine comprising a turbocharging system including a turbocharger (7) with a turbine (8) connected to at least one exhaust gas outlet of exhaust manifold (5) of said engine, as well as an outside air compressor (10), a line (15, 18) for partial transfer of the compressed air from the compressor to an inlet on the manifold communicating with the turbine, and an EGR line (21) connecting an exhaust gas outlet to a compressed air intake line (4).

### FIELD OF THE INVENTION

The present invention relates to a device for controlling a device feeding an amount of air to the intake of a turbocharged internal-combustion engine, notably a stationary engine or an automotive or industrial vehicle engine.

In particular, the present invention is suited for diesel engines equipped with an exhaust gas recirculation system.

### BACKGROUND OF THE INVENTION

As it is widely known, the power delivered by an internal-combustion engine depends on the amount of air fed to the combustion chamber of this engine, which amount of air is itself proportional to the density of this air.

Thus, it is usual to increase this amount of air through compression of the outside air before it is allowed into this combustion chamber. This operation, known as turbocharging, can be carried out using any means such as a turbocharger or a driven compressor, which can be a centrifugal or a positive-displacement compressor.

The turbocharger used for turbocharging comprises a rotary single-flow or double-flow turbine connected by a shaft to a rotary compressor. The exhaust gases from the engine flow through the turbine, which is then rotated. This rotation is thereafter transmitted to the compressor which, by its rotation, compresses the outside air before it is fed to the combustion chamber.

As is better described in French patent application No. 2,478,736, it is intended to increase the compression of the outside air by the compressor even further so as to be able to significantly amplify this amount of compressed air in the compression chamber of the engine.

This is achieved more particularly by increasing the rotational speed of the turbine and therefore of the compressor.

A fluid amplifier circuit, referred to as boost circuit, is therefore used, by means of which part of the compressed air exiting the compressor is diverted in order to be directly allowed to the turbine inlet while mixing with the exhaust gases. This turbine is then traversed by a larger amount of fluid (mixture of compressed air and exhaust gas), which allows the rotational speed of the turbine, and therefore of the compressor, to be increased. This compressor speed increase thus allows to raise the pressure of the outside air that is compressed in this compressor prior to being fed to the combustion chamber of the engine.

Thus, the compressed air has a higher density, which allows the amount of air contained in the combustion chamber to be increased.

This type of turbocharged engine, although satisfactory, however involves some not insignificant drawbacks.

Indeed, the flow of compressed air admitted at the turbine inlet is not correctly controlled, which may lead to dysfunctional engines.

Thus, by way of example, in case of too large amounts of compressed air diverted to the turbine inlet, the exhaust gases entering the turbine are cooled too much by this air, which causes a decrease in the overall turbocharging efficiency.

Furthermore, one of the major difficulties with the present turbocharging concept lies in the compatibility thereof with exhaust gas recirculation. Indeed, most diesel engines are equipped with an exhaust gas recirculation circuit, referred to as EGR circuit, for limiting NOx emissions at source.

Exhaust gas recirculation is generally achieved by means of a high-pressure (HP) circuit withdrawing the gas upstream from the turbine and sending it downstream from the intake air compressor. The recirculated exhaust gas circulating strictly in the opposite direction to the air diverted from the boost circuit, there is a likelihood of conflict between the two systems, with the effects cancelling each other out. It is thus necessary to define a specific air loop architecture allowing the boost circuit and the EGR circuit to be made compatible, in particular in simultaneous operation.

Document EP-1,138,928 describes an EGR circuit and a boost circuit distinct in all respects, but not optimized for simultaneous operation.

On the other hand, the present invention relates to an optimized air and exhaust gas recirculation loop architecture enabling to use, in a single engine, an EGR circuit and a boost circuit, and a substantially simultaneous operation.

### SUMMARY OF THE INVENTION

The present invention thus relates to a device for controlling the amount of air fed to the intake of a turbocharged internal-combustion engine comprising a turbocharging system including a turbocharger with a turbine connected to at least one exhaust gas outlet of the exhaust manifold of said engine, as well as an outside air compressor, a line for partial transfer of the compressed air from the compressor to an inlet on the manifold communicating with the turbine, and an exhaust gas recirculation line connecting an exhaust gas outlet and a compressed air intake line, characterized in that said compressed air inlet and said exhaust gas outlet are spaced apart on the exhaust gas manifold.

The exhaust gas outlet from the manifold to said turbine can be arranged between the inlet of said compressed air inlet and said exhaust gas outlet.

The compressed air inlet and the exhaust gas outlet can be arranged opposite each other on the exhaust manifold.

The device can comprise a controlled throttling system on the compressed air transfer circuit and on the exhaust gas recirculation circuit for controlling the exhaust gas circulation and the compressed air transfer.

The throttling system can include at least one valve on the recirculated exhaust gas circuit and a valve on the partial transfer circuit.

The throttling system can comprise at least one four-way valve.

The invention also relates to a method for controlling the amount of air fed to the intake of a turbocharged internal-combustion engine comprising a turbocharging system including a turbocharger with a turbine connected to at least one exhaust gas outlet of the exhaust manifold of said engine, as well as an outside air compressor, a line for partial transfer of the compressed air from the compressor to an inlet on the manifold communicating with the turbine, and a recirculated exhaust gas line connecting an exhaust gas outlet and a compressed air intake line, characterized in that said compressed air inlet and said exhaust gas outlet are spaced apart on the exhaust gas manifold.

The exhaust gas outlet from the manifold to said turbine can be arranged between the inlet of said compressed air inlet and said exhaust gas outlet.

Said compressed air inlet and said exhaust gas outlet can be arranged opposite each other on the exhaust manifold.

### BRIEF DESCRIPTION OF THE FIGURES

Other features and advantages of the invention will be clear from reading the description hereafter, given by way of non limitative example, with reference to the accompanying figures wherein:

FIG. 1 illustrates an internal-combustion engine with its turbocharging and EGR device according to the invention, and

FIG. 2 shows a variant of the internal-combustion engine according to the invention.

### DETAILED DESCRIPTION OF THE INVENTION

When operating the EGR circuit and the boost circuit, it should be considered that the average pressure at the intake is generally higher than the average pressure at the exhaust. However, it is known that the instantaneous pressure at the exhaust has phases where it is higher than the instantaneous intake pressure. Thus, it is possible to achieve exhaust gas recirculation but non-return valves are necessary in the EGR circuit.

To operate the boost circuit under such conditions and simultaneously with the EGR circuit according to the invention, the two circuits are connected on the exhaust manifold at two sufficiently distant points and the exhaust gas outlet towards the turbine inlet is positioned between said two points.

Thus, the air from the boost circuit will preferably flow towards the turbine inlet instead of substantially mixing with the EGR exhaust gas and disturbing the EGR circulation.

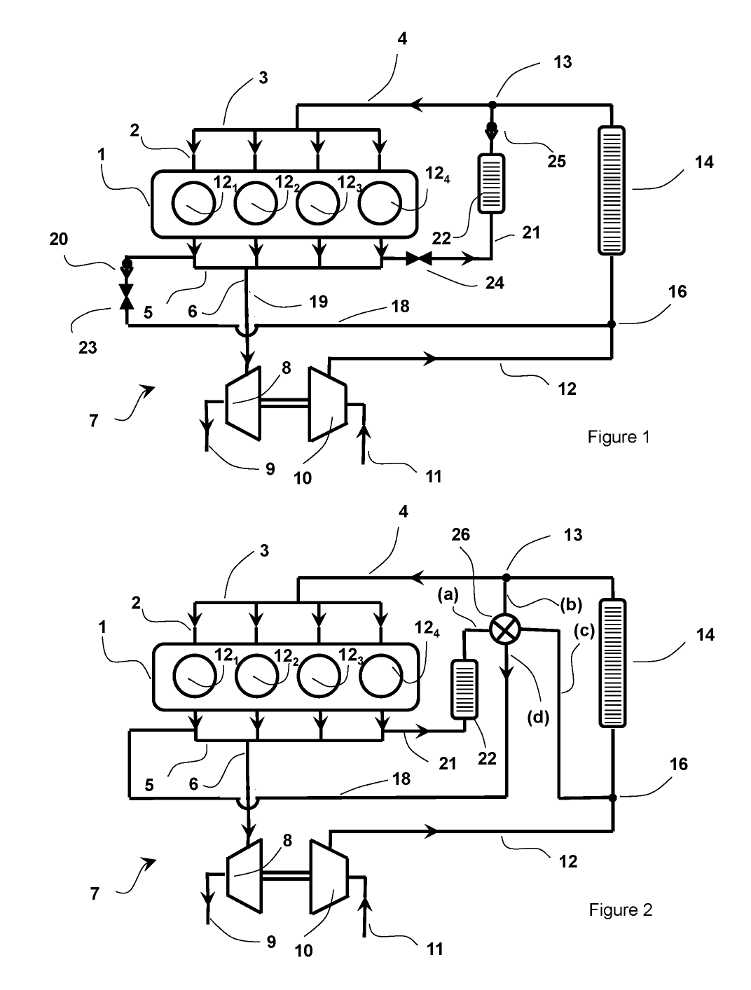

In FIG. 1, internal-combustion engine 1 comprises at least two cylinders, here four cylinders with reference numerals 12₁ to 12₄ from the left of the figure.

Preferably, this engine is a direct-injection internal-combustion engine, notably of diesel type, which by no means excludes any other type of internal-combustion engine.

Each cylinder comprises intake means with at least one intake valve controlling an intake pipe 2. The intake pipes lead to an intake manifold 3 supplied with intake air, such as compressed air, through a supply line 4.

Each cylinder also comprises burnt gas exhaust means with at least one exhaust valve controlling an exhaust pipe leading to an exhaust manifold 5.

Exhaust gas outlet 6 of the exhaust manifold leads to a turbocharger 7 used for air compression, and more specifically to the expansion turbine 8 of this turbocharger.

As illustrated in FIG. 1, the turbocharger is a single-scroll turbocharger.

The invention is not limited to a single-scroll turbocharger, it is also applicable to twin-scroll turbochargers.

Gas outlet 9 of turbine 8 is conventionally connected to the exhaust line of the engine.

Compressor 10 of turbocharger 7 comprises an outside air intake 11 supplied by a supply line. The compressed air outlet of this compressor is connected to supply line 4 of intake manifold 3 by a line 12. The junction point between lines 4 and 12 is denoted by 13.

Advantageously, a compressed air cooling radiator 14 may be provided on line 12, between compressor 10 and line 4.

As is better seen in FIG. 1, a transfer line 18 allows circulation of part of the compressed air from compressor 10 towards the inlet of turbine 8.

More precisely, this partial transfer line 18 originates from line 12, at an intersection point 16 between the compressor and cooling radiator 14. Branch 18 leads to exhaust manifold 5 and to exhaust gas outlet 6 towards turbine 8.

A line 21 connects exhaust manifold 5 to intake line 4. It preferably runs through an exchanger 22 suited for cooling the exhaust gases.

Preferably, this line 21, referred to as EGR line, is connected to an orifice of the exhaust manifold provided at a distance from the inlet intended for the air from the boost circuit delivered by transfer line 18. Furthermore, gas outlet line 6 is arranged between the outlet orifices of the EGR circuit and the inlet orifices of the boost circuit so as to be compatible with the fluid circulations induced by the EGR and boost circuits.

Lines 18 and 21 are respectively equipped with valves 23 and 24, preferably proportional valves.

Branch 18 also comprises a non-return valve 20, which prevents circulation of the fluids from the exhaust manifold to compressor 10, and EGR line 21 also comprises a non-return valve 25.

This configuration thus allows, during operation of the engine, to take advantage of the exhaust low-pressure zones occasionally prevailing in the exhaust manifold in order to feed compressed air into the turbine and thus to increase the flow rate of this turbine, and therefore of the compressor. This also allows to achieve more efficient turbocharging at low engine speeds, and notably to manage transient phases with suitable control strategies for the proportional valves.

During operation, in case a large amount of air is required in the cylinders, opening of valve 23 is controlled so as to feed compressed air from compressor 10 into turbine 8. Valve 24 is controlled concurrently in order to obtain recirculated exhaust gases if necessary at this operating point.

The compressed air exiting compressor 10 circulates in line 18 prior to reaching the exhaust gas inlet of turbine 8, thus providing surplus fluid supply to this turbine.

Thus, the turbine is traversed not only by the exhaust gases from manifold 5, but also by compressed air that comes on top of these gases. Therefore, the rotation of the turbine is increased, which causes an increase in the rotation of the compressor and, consequently, an increase in the pressure of the compressed air exiting this compressor.

In this configuration, the air of the boost circuit does not flow through exchanger 14.

In order to operate with recirculated exhaust gases, valve 24 is open. A portion of the exhaust gases is fed into intake line 4 after passing through exchanger 22. This operates when the average pressure at the exhaust is higher than the average pressure at the intake.

It can be noted that valves 23 and 24 may be replaced with a multi-way valve whose function is equivalent for controlling the various flow passage instances.

Furthermore, it is clear that valve 24 (EGR valve) can be arranged upstream (FIG. 1) or downstream (not shown) from heat exchanger 22; also, the position of non-return valve 25 is not imposed on line 21.

Thus, in the present invention, the respective positions:—of the branch connection of the EGR line,—of line 6 communicating with the inlet of turbine 8, and—of the inlet of the air transfer line 18 of the boost circuit enable optimized simultaneous operation of the EGR circuit and the boost circuit.

The variant of FIG. 2 differs from FIG. 1 in that it comprises a four-way distribution system 26, a rotary ball system for example, which fulfils the functions of valves 23 and 24 according to the configuration of FIG. 1.

Therefore, the four ways are:
(a) inlet of the EGR line,
(b) outlet of the EGR line towards intake 3,
(c) inlet of the boost circuit air portion,
(d) outlet of the boost circuit air towards turbine 8.

Depending on the position of the rotary ball, the following configurations can be selected:
EGR and boost by communicating (a) and (b), (c) and (d),
EGR alone by communicating (a) and (b), and (c) closed,
Boost alone by communicating (c) and (d), and (b) closed,
No EGR and no boost by closing all the ways.

1. A device for controlling the amount of air fed to the intake of a turbocharged internal-combustion engine comprising a turbocharging system including a turbocharger with a turbine connected to at least one exhaust gas outlet of the exhaust manifold of the engine, as well as an outside air compressor, a line for partial transfer of the compressed air from the compressor to an inlet on the manifold communicating with the turbine, and an exhaust gas recirculation line connecting an exhaust gas outlet and a compressed air intake line, wherein the compressed air inlet and the exhaust gas outlet are spaced apart on the exhaust gas manifold.

2. A device as claimed in claim 1, wherein the exhaust gas outlet from the manifold to the turbine is arranged between the inlet of the compressed air inlet and the exhaust gas outlet.

3. A device as claimed in claim 1, wherein the compressed air inlet and the exhaust gas outlet are arranged opposite each other on the exhaust manifold.

4. A device as claimed in claim 1, comprising a controlled throttling system on the compressed air transfer circuit and on the exhaust gas recirculation circuit EGR for controlling the exhaust gas circulation and the compressed air transfer.

5. A device as claimed in claim 4, wherein the throttling system includes at least one valve on recirculated exhaust gas circuit and a valve on partial transfer circuit.

6. A device as claimed in claim 4, wherein the throttling system comprises at least one four-way valve.

7. A method for controlling the amount of air fed to the intake of a turbocharged internal-combustion engine comprising a turbocharging system including a turbocharger with a turbine connected to at least one exhaust gas outlet of exhaust manifold of the engine, as well as an outside air compressor, a line for partial transfer of the compressed air from the compressor to an inlet on the manifold communicating with the turbine, and a recirculated exhaust gas line connecting an exhaust gas outlet and a compressed air intake line, wherein the compressed air inlet and the exhaust gas outlet are spaced apart on the exhaust gas manifold.

8. A method as claimed in claim 7, wherein the exhaust gas outlet from the manifold to the turbine is arranged between the inlet of the compressed air inlet and the exhaust gas outlet.

9. A method as claimed in any one of claim 7, wherein the compressed air inlet and the exhaust gas outlet are arranged opposite each other on the exhaust manifold.

10. Application of the device as claimed in claim 1.

11. A combination of a turbocharged internal-combustion diesel engine and the device as claimed in claim 1 for controlling the amount of air fed to an intake of the turbocharged internal-combustion diesel engine.

12. A method as claimed in claim 7, wherein the turbocharged internal-combustion engine is a turbocharged internal-combustion diesel engine.
